(19) United States
(12) Patent Application Publication
(10) Pub. No.: US 2014/0177272 A1
(43) Pub. Date: Jun. 26, 2014

(54) BACKLIGHT MODULE

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/949,249

(22) Filed: Jul. 24, 2013

(30) Foreign Application Priority Data
Dec. 21, 2012 (TW) 101148892

(51) Int. Cl. F21V 8/00

(52) U.S. Cl. CPC G02B 6/0018
USPC 362/608

(57) ABSTRACT

A backlight module includes a light guiding board and a number of LED light sources located a lateral side of the light guiding board. The light guiding board includes a top surface and a bottom surface opposite to the top surface. A slot is defined at the lateral side of the light guiding board adjacent to the LED light sources. The slot is depressed away from the LED light sources. The slot extends along a direction where the LED light sources are arranged along. Confronting faces of a plurality of protrusions defining the slot refract the light when the light is emitted from the LED light sources and enters into the light guiding board to change a transmitting direction of the light. The bottom surface of the light guiding board is a light reflecting surface.

### BACKGROUND

1. Technical Field

The present disclosure relates to backlight modules, and more particularly to a backlight module which can improve utilization efficiency of light.

2. Description of Related Art

LEDs (Light Emitting Diodes) have been widely promoted as light sources of electronic devices owing to many advantages, such as high luminosity, low operational voltage and low power consumption. However, the backlight module of an LCD (liquid crystal display) panel includes a light guiding board and a number of LED light sources located at one side of the light guiding board. The number of LED light sources is arranged in a row horizontally; a part of light generated by the LED light sources which enters the light guiding board along a direction parallel to a top surface of the light guiding board directly runs through the light guiding board and leaves it from an opposite side of the light guiding board without being directed to a bottom surface of the light guiding board which has a plurality of light reflecting protrusions formed thereon. This part of light does not radiate from a light output surface (i.e., top surface) of the light guiding board, whereby the utilization rate of the light of the LED light sources of the backlight module is low.

Therefore, a backlight module capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic, perspective view of a backlight module in accordance with an embodiment of the present disclosure.

FIG. 2 shows an inverted aspect of the backlight module of FIG. 1.

FIG. 3 shows a top view of the backlight module of FIG. 1.

FIG. 4 shows a lateral side view of the backlight module of FIG. 1.

### DETAILED DESCRIPTION

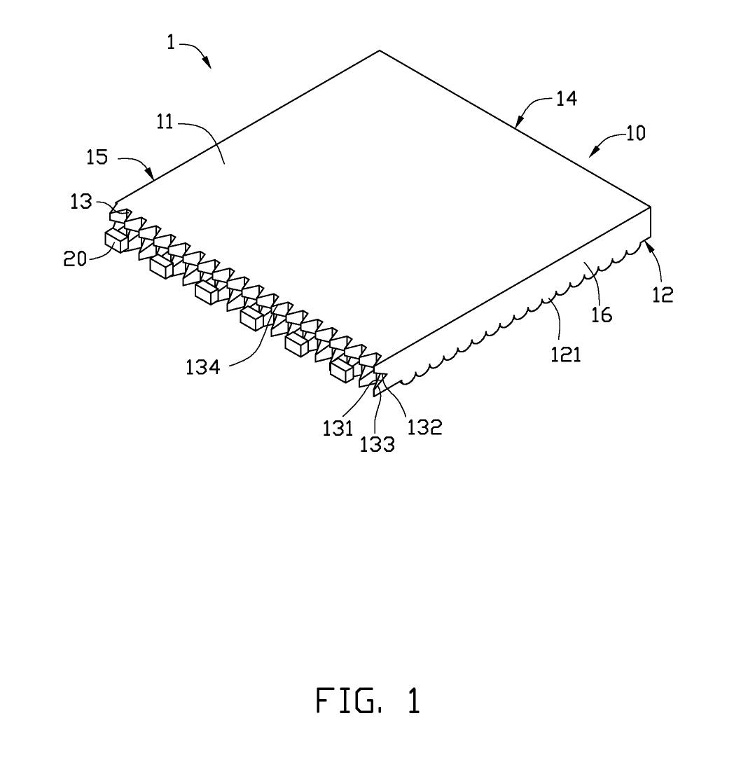

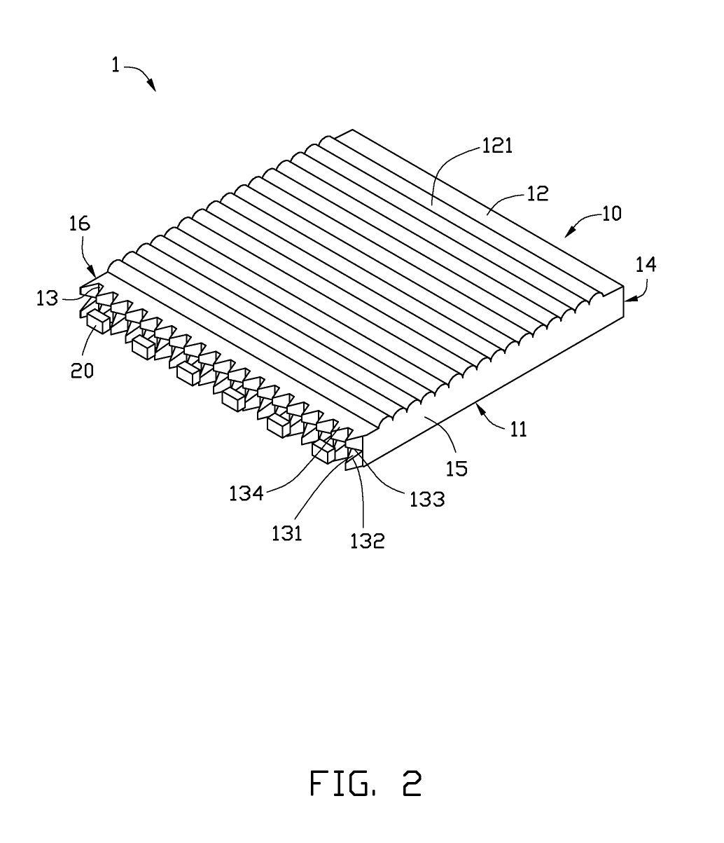

Referring to FIGS. 1 and 2, a backlight module 1 in accordance with an exemplary embodiment of the present disclosure includes a light guiding board 10 and a number of LED light sources 20 located at a front side of the light guiding board 10.

The light guiding board 10 is a thin and flat rectangular board, and the light guiding board 10 includes a top surface 11 and a bottom surface 12 opposite to the top surface 11 and a lateral surface (not labeled) connecting the top surface 11 to the bottom surface 12. In this embodiment, the lateral surface includes a front surface 13, a rear surface 14 opposite to the front surface 13, a left surface 15 and a right surface 16 opposite to the left surface 15, wherein the front surface 13, the rear surface 14, the left surface 15 and the right surface 16 each are perpendicular to the top surface 11 and the bottom surface 12. A critical angle of total reflection of the light transmitted towards the air from the light guiding board 10 is defined as β.

The top surface 11 is a flat surface, and the bottom surface 12 forms a number of continuous protrusion strips 121. The bottom surface 12 has a characteristic of reflecting light. The number of protrusion strips 121 extends from the left surface 15 to the right surface 16 of the light guiding board 10, and they are parallel to each other. In this embodiment, the cross-section of each protrusion strip 121 is curved, convex downwardly. In other embodiment, the cross-section of each protrusion strip 121 can be V-shaped or other shape, and the number of protrusion strips 121 can be spaced from each other.

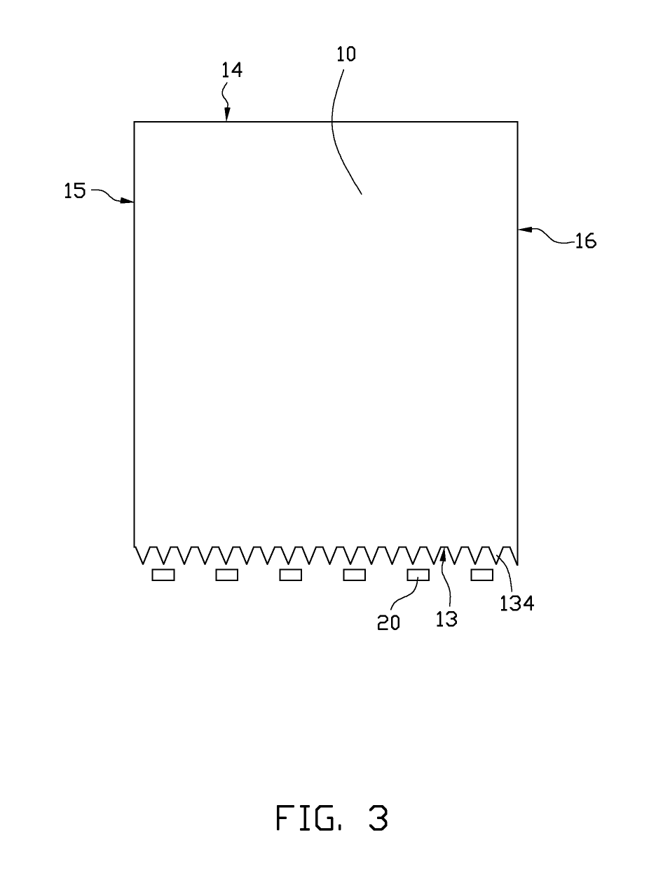

Referring to FIG. 3, in the forward direction of the front surface 13, a number of protrusions 134 are formed thereon, and the protrusions 134 are spaced from each other. The protrusions 134 are equidistantly arranged from the left surface 15 to the right surface 16 of the light guiding board 10, and the protrusions 134 are divided into a top row and a bottom row spaced from each other by a slot 131. In this embodiment, each protrusion 134 is a triangular protrusion with triangular top and bottom faces and trapezoid side faces intersecting each other at a front edge of each protrusion 134. The top face of each protrusion 134 in the top row is coplanar with the top surface 11 while the bottom face of each protrusion 134 in the bottom row is coplanar with the bottom surface 12. The bottom face 132 each protrusion 134 in the top row is inclined upwardly along the forward direction while the top face 133 of each protrusion 134 in the bottom row is inclined downwardly along the forward direction. The protrusions 134 refract the light from the LED light sources 20 when the light enters into the light guiding board 10 to change a transmitting direction of the light thereby enlarging the incident angle of the light into the light guiding board 10. In the vertical direction of the front surface 13, the slot 131 is defined at the middle thereof, and the slot 131 is depressed towards the rear surface 14. The slot 131 extends from the left surface 15 to the right surface 16 of the light guiding board 10. The LED light sources 20 face the slot 131 and each are located among four corresponding protrusions 134 of the top and bottom rows, whereby light from the LED light sources 20 are refracted by the confronting top and bottom faces and confronting lateral faces of the four corresponding protrusions 134 to enter the light guiding board 10.

The number of LED light sources 20 just face the front surface 13 of the light guiding board 10, and are spaced from the light guiding board 10.

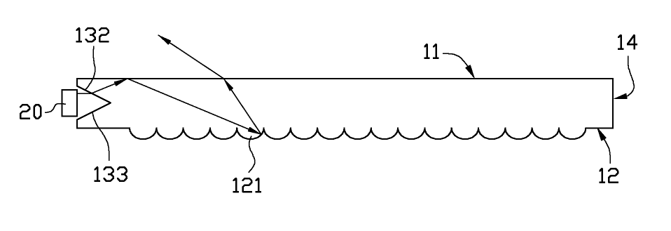

Referring to FIG. 4, the slot 131 has a V-shaped configuration. In use of the backlight module 1, the light emitted from the number of LED light sources 20 is transmitted towards the protrusions 134 and the slot 131 of the light guiding board 10 along various directions, and is further refracted by the protrusions 134 to the interior of the light guiding board 10. Part of the light which is emitted from the number of LED light sources 20 is parallel to the top surface 11 of the light guiding board 10. When the part of the light projects to the bottom face 132 or the top face 133 of the protrusions 134, it is refracted by the bottom face 132 or the top face 133 to deviate from its original direction to project toward the top surface 11 or the bottom surface 12 of the light guiding board 10.

Hereafter it takes the light path of FIG. 4 as an example for further description of the present disclosure. The light which emits from the LED light source 20 which is parallel to the top surface 11 is refracted by the bottom face 132 of the protrusion 134 in the top row to project to the top surface 11 of the light guiding board 10. When the angle of incidence of the light relative to the top surface 11 is greater than or equal to β, the light will be reflected back by the top surface 11 towards the bottom surface 12 of the light guiding board 10. For the bottom surface 12 having a characteristic of reflecting light by the formation of a number of continually protrusion strips 121 thereon, the light which is reflected back towards the bottom surface 12 will be reflected thereby to the top surface 11. When the light transmits to the top surface 11 once again, the angle of incidence of the light relative to the top surface 11 is changed by the protrusion strips 121 to be smaller than β. So, the light can project from the top surface 11 to an external environment to illuminate an LCD (not shown) over the light guiding plate 10. Alternatively, when the angle of incidence of the light relative to the top surface 11 is less than β after the light is immediately refracted by the top face 132, the light can directly project outwardly from the top surface 11. Anyway, the light will eventually project outward from the top surface 11, which is the light output surface of the light guiding plate 10. Accordingly, the utilization of the light from the LED light sources 20 is enhanced.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module, comprising:
a light guiding board, the light guiding board comprising a top surface and a bottom surface opposite to the top surface, the top surface being a light output surface of the backlight module; and
a plurality of LED light sources located a lateral side of the light guiding board;
wherein a plurality of protrusions is formed on the lateral side of the light guiding board, a slot is defined in the plurality of protrusions at the lateral side of the light guiding board adjacent to the LED light sources, the slot is depressed away from the LED light sources, the slot extends along a direction where the LED light sources are arranged along, the slot is located between confronting faces of each two adjacent top and bottom protrusions, the confronting faces refract the light when the light enters into the light guiding board to change a transmitting direction of the light toward at least one of the top and bottom surfaces, and the bottom surface of the light guiding board is a light reflecting surface.

2. The backlight module of claim 1, wherein a number of protrusion strips are formed in the bottom surface, and an extending direction of each of the protrusion strips extends along the direction where the LED light sources are arranged along.

3. The backlight module of claim 2, wherein the cross-section of each protrusion strip is curved, convex downwardly.

4. The backlight module of claim 2, wherein the number of protrusion strips are formed on the bottom surface continually.

5. The backlight module of claim 1, wherein each protrusion has a triangular outer face coplanar with one of the top or bottom surface, a triangular inner face constituting one of the confronting faces and two trapezoid lateral faces inserting each other at a front edge of each protrusion.

6. The backlight module of claim 1, wherein the plurality of protrusions are divided into a top row and a bottom row and each LED light source faces the slot and is located among four corresponding adjacent protrusions.

7. The backlight module of claim 6, wherein the triangular inner face of each protrusion in the top row is inclined upwardly along a forward direction, and the triangular inner face of each protrusion in the bottom row is inclined downwardly along the forward direction.

8. The backlight module of claim 6, wherein the plurality of protrusions are spaced from each other.

9. The backlight module of claim 6, wherein the slot has V-shaped configuration.
